(19) United States
(12) Patent Application Publication
(10) Pub. No.: US 2024/0099470 A1
(43) Pub. Date: Mar. 28, 2024

(54) EASY-ASSEMBLY BED, MULTIPURPOSE TABLE, AND TRANSPORTATION LIGHTWEIGHT BOARD

(71) Applicants: TOPPAN INC., Tokyo (JP); KINKI UNIVERSITY, Osaka (JP)

(72) Inventors: Hajime MONZEN, Shiga (JP); Mikoto TAMURA, Osaka (JP); Masaru HAYAKAWA, Tokyo (JP); Manabu TSUJINO, Tokyo (JP); Takashi MIZOBUCHI, Tokyo (JP); Nobuo HAMA, Hyogo (JP); Yuichirou FUJIKAWA, Osaka (JP)

(73) Assignees: TOPPAN INC., Tokyo (JP); KINKI UNIVERSITY, Osaka (JP)

(21) Appl. No.: 18/268,052

(22) PCT Filed: Dec. 20, 2021
(86) PCT No.: PCT/JP2021/046966

§ 371 Date: Jun. 16, 2023

(30) Foreign Application Priority Data
Dec. 21, 2020 (JP) 2020-211252

(51) Int. Cl. A47C 19/00; A47B 96/20; A61G 7/05

(52) U.S. Cl. CPC A47C 19/005; A47B 96/206; A61G 7/05; A47B 2230/0088

(57) ABSTRACT

An easy-assembly bed includes a top plate, and a leg portion having a plurality of leg members that are linked using notched joints. The top plate is constituted of a bonded material, which includes a plate-shaped foam plate formed with a foam body, and a front board member and a rear board member having an identical shape to the foam plate and that are bonded to the rear surface and the front surface of the foam plate, respectively, and a top plate molded resin portion overing the cut ends of the bonded material with a molded resin; and the leg members are each constituted of a grooved bonded material, which includes a plate-shaped grooved foam plate having locking grooves and formed with a foam body, and a grooved front board member and a grooved rear board member on the front surface and the rear surface of the grooved foam plate.

### TECHNICAL FIELD

The present invention relates to an easy-assembly bed that is waterproof, lightweight, and can be easily assembled. The easy-assembly bed according to the present invention can also be used as a multipurpose table. Furthermore, the easy-assembly bed according to the present invention has a top plate that is usable as a lightweight board for transporting people and objects.

### BACKGROUND

In recent years, there has been a series of disasters that have caused widespread damage. Often, temporary evacuation to safe places is conducted in disaster areas. However, if damages occur to houses or over a wide area, the evacuation may continue for a certain period. In such cases, it is necessary to secure privacy and safe beds as well as food and clothing.

Most shelters generally have wooden floors. Lying directly on the wooden floor takes away body temperature even with a mat laid on the floor. Energy is also necessary to get up from the floor when waking up.

The easy-assembly bed is effective in such situations. The bed has a use surface that is positioned at a certain height from the floor, and therefore both in the case of shifting from a standing posture to a lying posture and in the case of waking up and then standing up, it is easy to shift one's posture by temporarily sitting on the use surface.

On the other hand, the beds used in such cases are often stored in normal situations. In other words, it is necessary to transport the beds from a storage place to an evacuation place. Moreover, since the demand for beds is high in evacuation places, it is necessary to transport a large number of beds.

Beds made of corrugated cardboard are very advantageous in terms of transportation, since the corrugated cardboard is lightweight. Patent Literature 1 provides a corrugated cardboard bed that can be transported without a bulky volume. The beds made of corrugated cardboard in recent years take advantage of the lightweight of the material and make full use of structures such as U-shaped or B-shaped structures that exhibit increased compression strength even though the number of components increases slightly. As a result, a certain level of strength is ensured despite the beds being made of corrugated cardboard.

Patent Literature 2 discloses a bed using plastic cardboard to solve the problem in that the corrugated cardboard has low water resistance. The plastic corrugated cardboard is made of corrugated cardboard that is formed by using a resin such as a polypropylene, so as to have both strength and water resistance.

Patent Literature 3 discloses a bed made of wood, which allows easy assembly. While wooden beds were conventionally assembled by connecting each part with fastening tools such as bolts, use of notched joints allows the beds to be assembled simply by locking notches to each other.

### CITATION LIST

### Patent Literature

PTL 1: Japanese Utility Model Registration No. 3226650
PTL 2: Japanese Patent Application Laid-Open No. 2012-235819
PTL 3: Japanese Patent Application Laid-Open No. 2020-110559

### SUMMARY OF INVENTION

### Technical Problem

As shown in Patent Literature 1, the number of components of the bed made of corrugated cardboard increases in order to ensure strength. As described above, the bed made of corrugated cardboard also has poor water resistance. Hence, in the event of disasters caused by a large amount of water, such as rain or flood, the strength of the bed is lost when the bed is exposed to water. In addition, when the bed made of corrugated cardboard is wet, a sanitary environment may be compromised due to reasons such as generation of insects such as psocoptera, posing a serious problem.

Meanwhile, the plastic corrugated cardboard as shown in Patent Literature 2 is made of plastic and therefore has high water resistance. However, the plastic corrugated cardboard has a corrugated cardboard structure in which a core with a waveform cross-section is interposed between upper and lower planar liners, which poses a problem in that water penetrates into the inside of the corrugated cardboard. In addition, it cannot be said that the plastic corrugated cardboard is structured to be resistant to forces applied in a direction perpendicular to the liners.

The wooden beds as shown in Patent Literature 3 are well-proven in terms of strength and water resistance. However, even though wood floats on water, the specific gravity is close to 1, and each member is heavy. Therefore, it cannot be said that the wooden beds are suitable for bulk transportation.

Moreover, the notched joints used in the wooden bed can provide a solid connection when respective locking grooves are formed with a negative tolerance and are hammered with a mallet or the like at the time of assembling a bed. However, a substantial amount of time and effort is required to disassemble the bed. On the other hand, when the locking grooves are formed with a positive tolerance, although assembling and disassembling the bed becomes easy, the bed experiences more rattling after assembly and there is a lack of connectivity between the members. As a result, when an attempt is made to lift the assembled bed, the components fall, and it is difficult to handle the assembled bed as an integrated article.

### Solution to Problem

The present invention has been conceived in light of the above-mentioned problems, and provides an easy-assembly bed that is lightweight, highly water resistant, and can be easily assembled.

Specifically, an easy-assembly bed according to the present invention is an easy-assembly bed including: a top plate and a leg portion, the leg portion having a plurality of leg members that are linked using notched joints, wherein:
the top plate is constituted of
   a bonded material, which includes a plate-shaped foam plate formed with a foam body, and a front board member and a rear board member that have an identical shape to the foam plate and that are bonded to a rear surface and a front surface of the foam plate, respectively, and
   a top plate molded resin portion covering cut ends of the bonded material with a molded resin; and
the leg members are each constituted of
   a grooved bonded material, which includes a plate-shaped grooved foam plate having locking grooves and formed with a foam body, and a grooved front board member and a grooved rear board member on a front surface and a rear surface of the grooved foam plate, respectively, the grooved front and rear members having an identical shape to the grooved foam plate, and
   a leg member molded resin portion covering cut ends of the grooved bonded material with a molded resin.

### Advantageous Effects of Invention

In the easy-assembly bed according to the present invention, since the front and rear board members are respectively placed on the front and rear surfaces of the foam plate, and the cut ends that are side surfaces, the foam plate, and the front and rear board members are molded with a molded resin, the foam plate is sealed with the resin and the front and rear board members. Therefore, since the foam body is completely protected from penetration of water, it has excellent water resistance.

In addition, since the center part is formed with a foam body, the specific gravity is low, and the specific gravity of the top plate and the leg portion is lower than that of wood. Naturally, both the top plate and the leg portion float on water. Furthermore, since the top plate is mostly made of a foam body, it has high heat retaining properties. This makes it possible to suppress a decrease in the body temperature of a person who sleeps on the top plate.

Moreover, as the structure of the foam body sandwiched between the board members made of plastic is strong, a bed with sufficient strength can be obtained even with a small number of components (a top plate and several leg members). Furthermore, since the number of components is small, it is extremely easy to assemble the assembly bed, and even those who have never seen the assembly bed can assemble the bed in a few minutes without instructions. Since the number of components is small and all the components are planar, the bed does not become bulky when the components are stored.

In addition, not only does the molded resin portion that is molded with a molded resin seal the foam body and the upper and lower top plates, but the molded resin portion can also be formed continuously with an additional shape portion, which exhibits other functions. Specifically, the additional shape portion is an L-form shape or the like provided on the rear surface of the top plate so as to lock the leg portion and the top plate. Therefore, it is not necessary to separately prepare components that exhibit such functions.

Since the resin molding is also applied to the parts of the locking grooves, the molded resin absorbs the tolerance between the components when the leg members are joined together by notched joints. This makes it easy to assemble and disassemble the bed, and the leg portion is not wobbly when the bed is assembled. As a result, when the leg members are connected to one another, they can be carried as a leg portion.

In addition, since the assembly bed according to the present invention has no metal part, there is no interaction with magnetism or radiation. Therefore, it is possible to directly examine a living body laid on the top plate by CT or MRI. It is also possible to place the bed itself in an MRI chamber. More specific examples of use include use as a top plate of an ambulance stretcher or use as a stretcher at a security inspection place in an airport.

### BRIEF DESCRIPTION OF DRAWINGS

FIG. 1 includes assembly drawings of an easy-assembly bed according to the present invention, in which (a) is an overall assembly drawing, (b) is a perspective view of an assembled leg portion, and (c) is a view of a corner of an assembled bed as viewed from a rear side.

FIG. 2 includes cross-sectional views of an end side of a top plate, in which (a) is an A-A cross section in FIGS. 1(a), and (b) is a B-B cross section in FIG. 1(a).

FIG. 3 includes assembly drawings of an easy-assembly bed in another mode according to the present invention, in which (a) is an overall assembly drawing, and (b) is a cross-sectional view of a link portion between the top plates.

FIG. 4 includes assembly drawings of an easy-assembly bed in another mode according to the present invention, in which both (a) and (b) are assembly drawings of the top plate and the leg portion.

FIG. 5 includes perspective views showing a medical transportation lightweight board according to the present invention, in which (a) shows a front surface, (b) shows a rear surface, (c) shows an enlarged view of a corner as viewed from the rear surface, and (d) shows a C-C cross section in (c).

FIG. 6 includes a plan view (a) and a side view (b) of the easy-assembly bed according to the present invention, fabricated in an example.

FIG. 7 is a graph showing the result of a load test for the easy-assembly bed in FIG. 6.

### DESCRIPTION OF EMBODIMENTS

Hereinafter, an easy-assembly bed according to the present invention will be described with reference to the drawings. The following description illustrates an embodiment of the present invention and is not intended to limit the present invention to the following description. The following description may be modified to the extent that it does not depart from the spirit of the present invention.

The easy-assembly bed according to the present invention can also be used as a multipurpose table as is. Furthermore, a top plate of the easy-assembly bed according to the present invention can be used as a transportation lightweight board, when the top plate is used as a single unit.

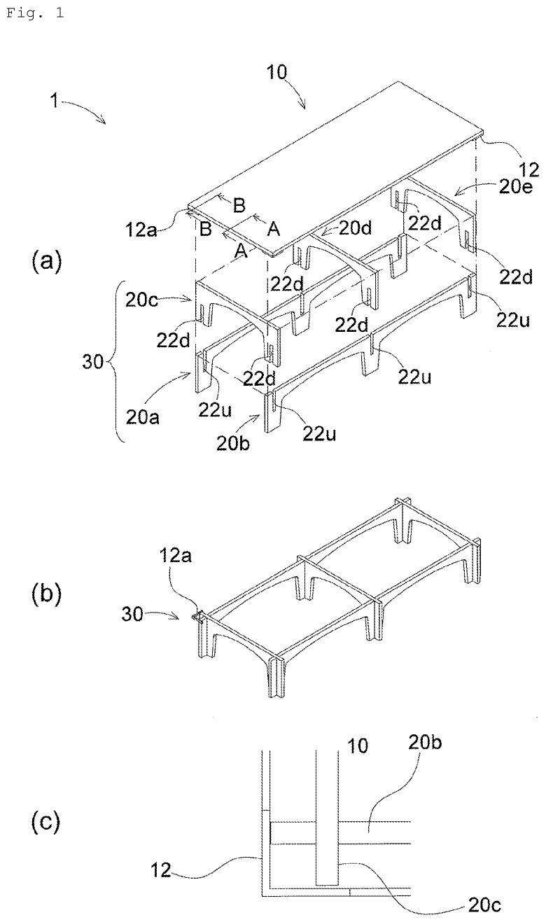

FIG. 1(a) shows an assembly drawing of an easy-assembly bed 1 according to the present invention. The easy-assembly bed 1 of the present invention is constituted of a top plate 10, and a leg portion 30 which is a combination of leg members 20. The leg portion 30 is formed with at least two or more leg members 20. In FIG. 1, five leg members 20 (reference signs 20a, 20b, 20c, 20d, and 20e) are used. For the purpose of explanation, the respective leg members are referred to as long leg members 20a and 20b, and short leg members 20c, 20d and 20e.

The top plate 10 is formed into a size and a shape that allows a person to lie on the plate. Although the top plate 10 is typically fabricated into a rectangle shape in plan view, the shape is not limited thereto. For convenience in transportation, the top plate 10 may be constituted of two or more top plates 10.

A height of about 30 cm is preferably adopted for the leg members 20 in order to avoid bacteria (viruses) and dust that move from the floor to the top plate 10. The leg members 20 may also have an arch shape as a reinforcing structure. The leg members 20 include locking grooves 22 (denoted by 22u or 22d in FIG. 1). Note that the locking grooves 22 are notches with a width equivalent to the thickness of the leg members 20. The locking grooves 22 are formed to have such a length that when the leg members 20 are linked by fitting the locking grooves 22 with each other, the upper ends and lower ends of the respective members are flush with each other.

The short leg members 20c, 20d and 20e each have two locking grooves 22, and the long leg members 20a and 20b each have three locking grooves 22, one each at both ends and in the center. The long leg members 20a and 20b each include upward locking grooves 22u. The short leg members 20c, 20d and 20e each include two downward locking grooves 22d, one each at both ends.

By engaging the locking grooves 22d of the short leg members 20c, 20d and 20e with the locking grooves 22u of the long leg members 20a and 20b, the long leg members 20a and 20b are connected to the short leg members 20c, 20d and 20e by notched joints. The leg portion 30 is completed by locking the three short leg members 20c, 20d and 20e to the two long leg members 20a and 20b (see FIG. 1(b)). When the top plate 10 is mounted on the completed leg portion 30, the easy-assembly bed 1 according to the present invention is completed.

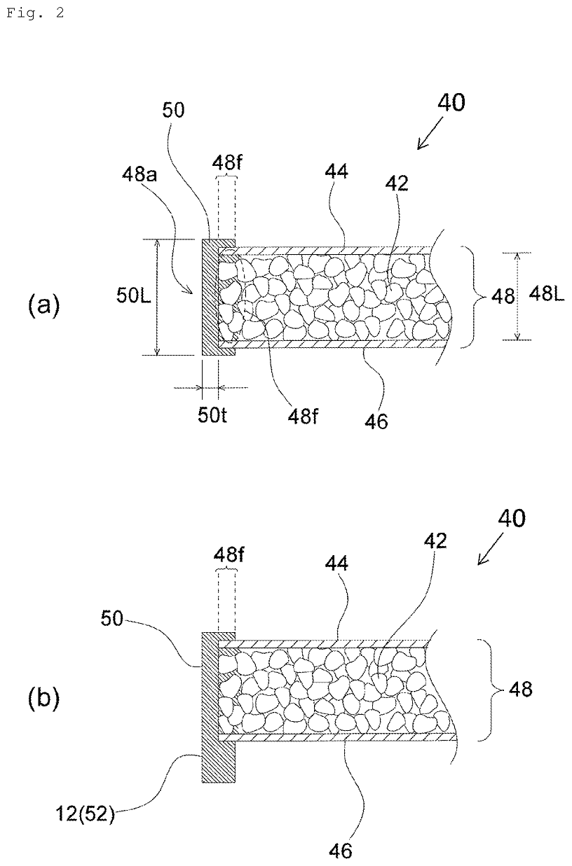

FIG. 2(a) shows the cross-section of a side end portion of the top plate 10 in a thickness direction (an A-A cross section of FIG. 1(a)). The cross section of the leg members 20 also have a similar structure in the thickness direction. The top plate 10 and the leg members 20 are collectively referred to as “bed members 40”.

The bed members 40 each have a plate-shaped foam plate 42 arranged in a center layer in the thickness direction, with a front board member 44 and a rear board member 46 being bonded to the front surface and the rear surface of the foam plate 42. The foam plate 42 with the front board member 44 and the rear board member 46 bonded thereto is referred to as a bonded material 48. The parts corresponding to the side surfaces of the bonded material 48 are referred to as cut ends 48a. The bonded material 48 of the top plate 10 may be referred to as a “top plate bonded material” and the bonded material 48 of each of the leg members 20 may be referred to as a “grooved bonded material”.

In the bed members 40, parts of the cut ends 48a are covered with a molded resin. The molded resin parts are each referred to as a molded resin portion 50. It can be said that in the molded resin portion 50, the front board member 44, the rear board member 46, and the foam plate 42 are molded at the cut ends 48a. The molded resin portion 50 of the top plate 10 may be referred to as a “top plate molded resin portion”, and the molded resin portion 50 of each of the leg members 20 may be referred to as a “leg member molded resin portion.”

The foam plate 42 is formed in the shape of a plate. Although the shape in plan view is not particularly limited, the thickness is small in comparison with the length and width. For the foam plate 42, materials that can typically be used as a foam body can be used. Examples of the materials include a polyurethane-based resin, a polystyrene-based resin, and a polyolefin-based resin. Here, a polyolefin includes a polyethylene and a polypropylene. Materials such as a phenol resin, a polyvinyl chloride, a urea resin, silicone, a polyimide, and a melamine resin can also be used. Note that the foam plate 42 of the top plate 10 may be referred to as a “top plate foam plate” and the foam plate 42 of each of the leg members 20 may be referred to as a “grooved foam plate”.

For the front board member 44 and the rear board member 46, plate-shaped resin or plate-shaped FRP can be suitable for use because the material itself is lightweight, strong, and water resistant. Here, the front board member 44 and the rear board member 46 may be made of different materials. The front board member 44 and the rear board member 46 may also be different in thickness. The front board member 44 and the rear board member 46 are bonded to the foam plate 42 with an adhesive. As a suitable adhesive to be used, a two-component epoxy-based adhesive or a two-component urethane-based adhesive can be used because no oxygen is present in the vicinity of the center of the foam plate 42, and therefore the adhesive needs to have a property of being curable even without air during curing. The front board member 44 and the rear board member 46 of the top plate 10 may be referred to as a “top plate front board member” and a “top plate rear board member”, respectively, and the front board member 44 and the rear board member 46 of each of the leg members 20 may be referred to as a “grooved front board member” and a “grooved rear board member,” respectively.

While the molded resin portion 50 covers all the cut ends 48a of the bonded material 48 with a molded resin, an additional shape portion 52 that is formed with a molded resin may further be provided. With reference to FIG. 1(a), at each of the four corners of the top plate 10, a drape-like regulation shape 12a is formed such that the shape of the corner is made to extend vertically downward from the rear board member 46.

The regulation shapes 12a are locked to the corner parts of the leg portion 30 when the top plate 10 is locked to the leg portion 30. Further, the regulation shapes 12a regulate the top plate 10 to prevent the top plate 10 from shifting over the leg portion 30. FIG. 1(b) shows the state in which the leg portion 30 and one regulation shape 12a are locked. In FIG. 1(b), the top plate 10 is omitted and only one regulation shape 12a of the top plate 10 is shown.

FIG. 1(c) shows the state where the long leg member 20b is fitted to the short leg member 20c and the top plate 10 is mounted as viewed from the rear side. FIG. 1(c) shows that the regulation shape 12a is in contact with end portions of the long leg member 20b and the short leg member 20c to regulate the movement of the top plate 10.

FIG. 2(b) shows the cross-section of a corner end portion of the top plate 10 in the thickness direction (a B-B cross section of FIG. 1(a)). The regulation shape 12a is continuously formed on the molded resin portion 50 by using the molded resin. Therefore, it can be said that the regulation shape 12a is an additional shape portion 52. The regulation shape 12a may be any shape as long as it is continuously formed on the molded resin portion 50. The additional shape portion 52 may also be formed on the leg members 20 as well as on the top plate 10.

The molded resin portion 50 is formed by attaching a mold corresponding to the molded resin portion 50 to the part of the cut ends 48a after the bonded material 48 is formed, and injecting a molded resin into the mold. In this case, when the shape corresponding to the additional shape portion 52 is also formed, the additional shape portion 52 can also be formed concurrently with the formation of the molded resin portion 50.

As the molded resin usable for the molded resin portion 50, the resin usable for the foam plate 42 can be used. However, the cut ends 48a of the bed members 40 may be subjected to accidental external force that is generated when the cut ends 48a are hit or rubbed. At the locking grooves 22 of the leg members 20, the molded resin portions 50 slide in contact with each other when the leg members 20 are locked to each other. Therefore, a highly durable urethane resin is a suitable material to be used for the molded resin portions 50.

There is no upper limit to a thickness 50t of the molded resin portion 50 as long as water cannot penetrate through the cut ends 48a of the bonded material 48. However, in many cases, the specific gravity of the molded resin is 1 g/cm³ or more. Thus, as the thickness 50t of the molded resin portion 50 becomes greater, the specific gravity of the easy-assembly bed 1 becomes higher. For the molded resin portion 50, a thickness 50t of about 2 to 10 mm is suitable.

On the other hand, a formation length 50L of the molded resin portion 50 may be formed greater than a thickness 48t of the bonded material 48. Here, the formation length 50L is the length of the molded resin covering the cut ends 48a of the bonded material 48 in the thickness direction of the bed members 40, and specifically, the length is the thickness of the bed members 40 as viewed from the side of the cut ends 48a (see FIG. 2(a)).

For example, to link the leg members 20 with notched joints without wobbling, the locking grooves 22 require high precision machining. However, the greater the formation length 50L of the molded resin portion 50 is formed than the thickness 48t of the bonded material 48, the more dimensional error can be absorbed. Of course, the formation length 50L of the molded resin portion 50 may be equal to the thickness 48t of the bonded material 48.

Again as can be seen in FIGS. 2(a) and 2(b), the molded resin injected into the mold spreads in a molten state in the mold and covers all the cut ends 48a of the bonded material 48. At this time, the molded resin partially penetrates into the inside of the foam plate 42. A region where the molded resin penetrates is referred to as a penetrated region 48f. The foam plate 42 and the molded resin are tightly connected to each other by the formation of the penetrated region 48f.

When the center layer is made of wood, a tape-shaped or flat plate-shaped material referred to as a cut end decorative material is bonded for reinforcement of the side surfaces. However, in each of the bed members 40 constituting the top plate 10 and the leg members 20, since the center layer is the foam plate 42, sufficient bonding strength cannot be obtained by bonding the cut end decorative materials to the foam plate 42 with an adhesive.

However, as in the present invention, when the penetrated regions 48f are formed in the foam plate 42 by molding the cut ends 48a of the bonded material 48, the molded resin portion 50 and the foam plate 42 can be bonded with a sufficiently strong bonding strength.

In the easy-assembly bed 1 according to the present invention, it is desirable that a total specific gravity of the top plate 10 and five leg members 20 is 0.6 g/cm³ or less. This is because the total weight can be reduced, and a large force is not required at the time of assembling and disassembling. In addition, when the specific gravity is 0.6 g/cm³ or less, the bed sufficiently floats on water. The specific gravity of the bed members 40 is determined by the size of each portion which is determined by the strength required for the bed. While the lower the specific gravity the better, there is no point in specifying a lower limit since there is no possibility of the specific gravity becoming zero or negative. In reality, 0.1 g/cm³ or more or 0.3 g/cm³ or more may be a realistic lower limit.

A method of assembling the easy-assembly bed 1 according to the present invention is as shown in FIG. 1. The method of assembly can be easily imagined simply by viewing six bed members 40 including the top plate 10 and leg members 20. Therefore, the ease of assembly is very high.

As shown in FIG. 1, while it is easy to assemble the top plate 10 and the six leg members 20 simply by viewing them, the grooves 22 of the leg members 20 that are joined with notched joints may be provided with the molded resin portions 50 of the same color. For example, the locking grooves 22d at the end of both the long leg member 20a and the long leg member 20b and the locking grooves 22d of the short leg member 20c may have molded resin portions 50 that are colored identically, so as to make them distinguishable from the other locking grooves 22. In this way, it is possible to easily link the two long leg members 20a and 20b and the short leg member 20c. When a U-shaped link body can be formed with the two long leg members 20a and 20b and the short leg member 20c, it becomes easy to lock the locking grooves 22d of the other short leg members 20d and 20e to the other locking grooves 22u of the long leg members 20a and 20b.

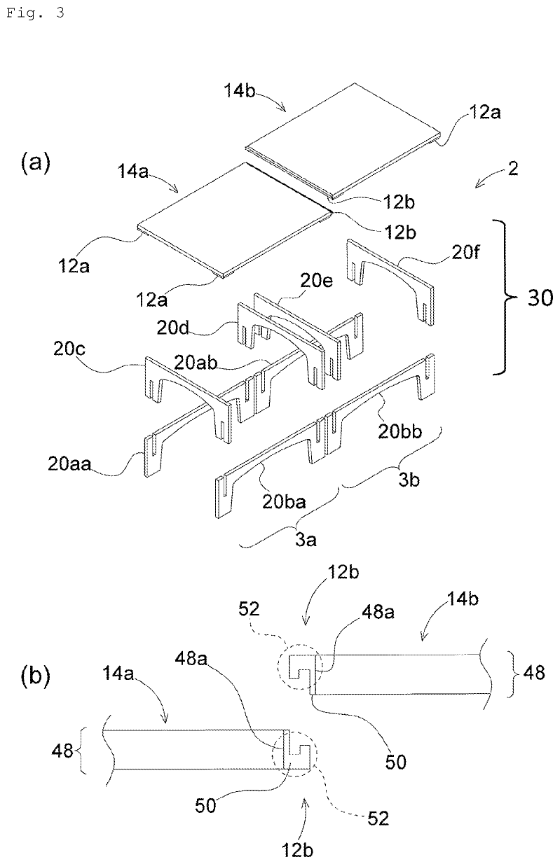

FIG. 3 shows another mode of the easy-assembly bed according to the present invention. In an easy-assembly bed 2, the top plate 10 is split into two plates, which are referred to as a top plate 14a and a top plate 14b, respectively. Four leg members 20 are prepared for each of the top plates 14a and 14b. As shown in FIG. 3(a), the leg members 20 are denoted by reference signs 20aa, 20ab, 20ba, 20bb, 20c, 20d, 20e, and 20f. These leg members 20 are assembled to form the leg portion 30. In other words, the leg portion 30 of the easy-assembly bed 2 is formed with the eight leg members 20. Here, the leg portion 30 may have the configuration of the leg portion 30 in FIG. 1.

One top plate 14 and the four leg members 20 are combined into a shape like that of a low dining table. This is referred to as a “half table 3.” Now, for the sake of convenience, two half tables 3 in FIG. 3 are referred to as a first half table 3a and a second half table 3b, respectively. By linking these half tables 3 to each other, the easy-assembly bed 2 is formed. The cut ends 48a of the top plates 14 of the respective half tables 3 face each other, and the cut ends 48a are provided with additional shape portions 52 used for linking.

FIG. 3(b) shows an enlarged view of the side surface of the end portions of the top plate 14a and the top plate 14b, which are linked with each other. At the cut ends 48a of the top plates 14a and 14b, hook-shaped link shapes 12b are formed, wherein the link shapes 12b are continuously formed from their respective molded resin portions 50 and locked with each other. The link shapes 12b are the additional shape portions 52. When the hook shapes in the link shapes 12b are locked to each other, the top plates 14a and 14b corresponding to the first half table 3a and the second half table 3b are linked to each other.

At the end sides opposite to the end sides where the link shapes 12b are formed, the L-shaped regulation shapes 12a shown in FIG. 1 are formed. The top plates 14a and 14b corresponding to the first half table 3a and the second half table 3b are linked to each other through the link shapes 12b (see FIG. 3(a)). On the other hand, at the other end portion of each of the top plates 14, the top plate 14 and the leg portion 30 are fixed by the regulation shape 12a. With these configurations, the easy-assembly bed 2 also functions as a single body easy-assembly bed.

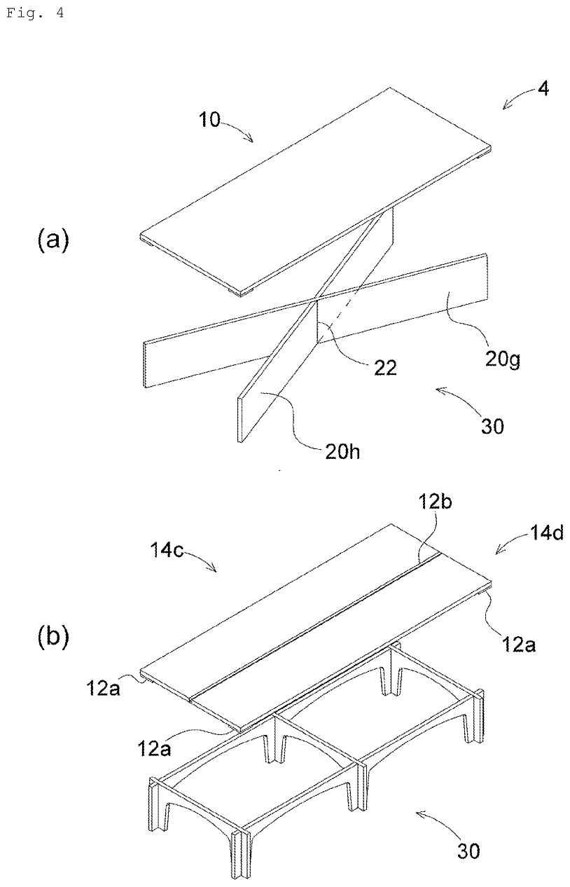

FIG. 4(a) shows an easy-assembly bed 4 in the case of having two leg members 20 (20g and 20h). The leg members 20 with locking grooves formed in the center are locked together in an X-shape in plan view by means of notched joints. The top plate may be identical to the top plate 10 in FIG. 1 or the top plates 14 as shown in FIG. 3. Thus, the leg portion 30 including at least two leg members 20 can constitute the easy-assembly bed 4.

FIG. 4(b) shows an easy-assembly bed 5 in the case where the top plate is formed with a top plate 14c and a top plate 14d obtained by splitting one top plate into two along a longitudinal direction. The leg portion 30 may be the same as the leg portion 30 in FIG. 1. Naturally, the leg portion 30 may be the same as any of the leg portions 30 in FIGS. 3 and 4(a). The link shapes 12b shown in FIG. 3 are formed in the link portions of the top plate 14c and the top plate 14d. In this way, when the top plate is split, the top plate may also be split along a longitudinal line.

The easy-assembly bed according to the present invention can be used as a bed and also as a multipurpose table. For example, the easy-assembly bed 1 shown in FIG. 1 can be used as a multipurpose table by modifying the length of the easy-assembly bed 1 to about the length of the half table 3 in FIG. 3. The application of the multipurpose table may include use as a low dining table.

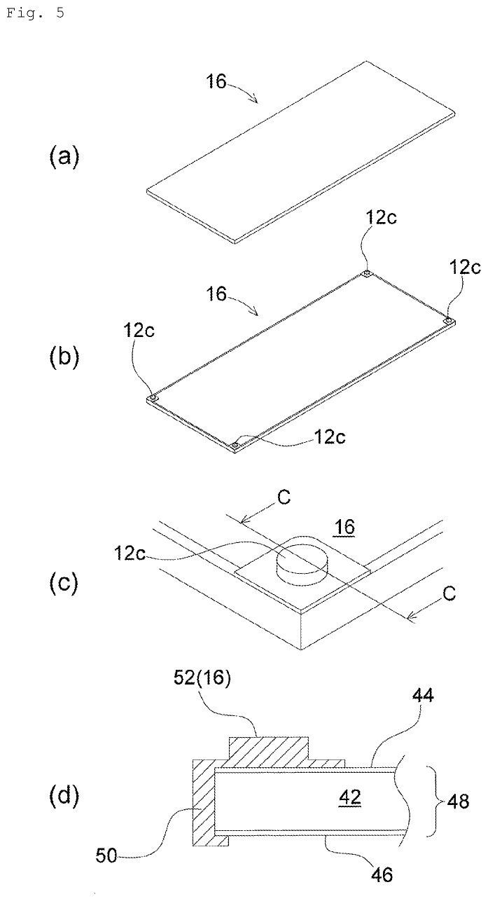

FIG. 5(a) shows a top plate 16 obtained by removing the regulation shapes 12a from the top plate 10 shown in FIG. 1. The cross-sectional structure is as shown in FIG. 2. The top plate 16 is highly permeable to radiation and can be suitably used as a medical transportation lightweight board.

FIG. 5(b) shows the case where the molded resin portion 50 of the top plate 16 in FIG. 5(a) has legs 12c formed as the additional shape portions 52. FIG. 5(b) shows the front and rear sides reversed. FIG. 5(c) shows an enlarged view of the additional shape portion 52, and FIG. 5(d) shows a C-C sectional view of FIG. 5(c).

By forming the legs 12c with such additional shape portions 52, it is possible to create spaces for hands to be inserted into when, for example, lifting the top plate 16 with an injured person being laid on, wherein the top plate 16 placed directly on the ground. In other words, the top plate 16 itself, with the additional shape portions 52 (legs 12c) added to the molded resin portion 50, can be used in the field of medical treatment. Such a top plate 16 can be referred to as a medical transportation lightweight board. The medical transportation lightweight board may also be made splittable as shown in FIGS. 3 and 4(b).

The medical transportation lightweight board using the top plate 16 does not use any metal at all and thus can be used for CT and MRI as it is. In other words, in an emergency, it is possible to perform a detailed examination of an injured person laying on the medical transportation lightweight board by CT or MRI without transferring the injured person to another stretcher or the like.

### Example

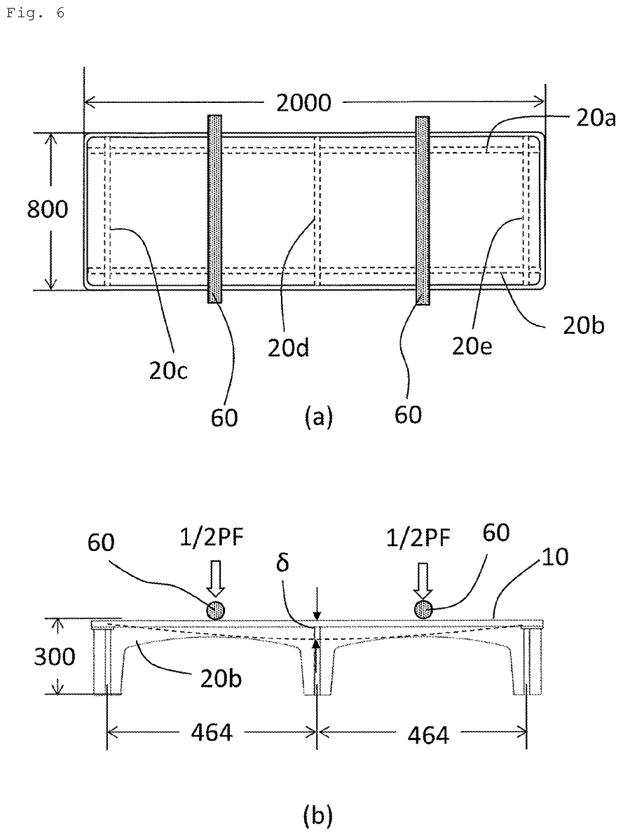

An easy-assembly bed of a type shown in FIG. 1 was actually fabricated and a load test was performed. FIG. 6 shows a plan view (FIG. 6(a)) and a side view (FIG. 6(b)) of the easy-assembly bed. The bed members 40 include the front board member 44 and the rear board member 46 which were both PG plates (glass cloth laminated sheet) with a thickness of 2 mm. The foam plate 42 was a polyurethane foam body. The molded resin portion was made of a polyurethane. The top plate 10 was 800 mm×2000 mm, and the height of the leg portion 30 was 300 mm. The total weight of the top plate 10 and the leg portion 30 was 7 kg.

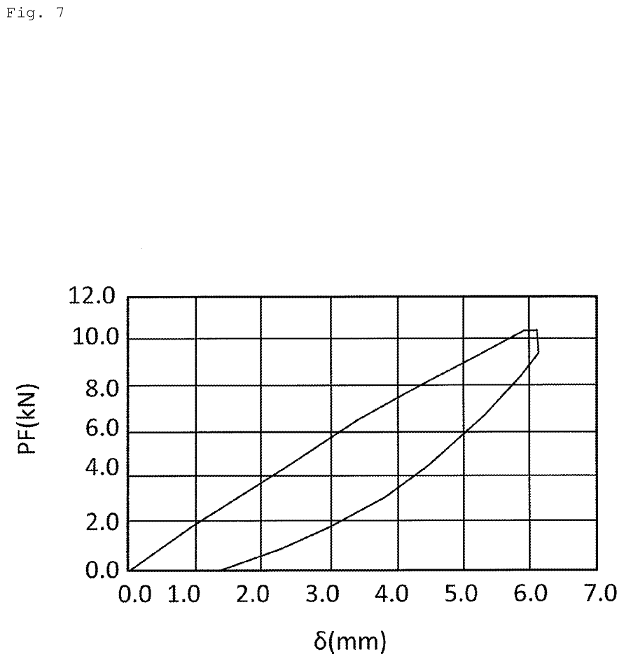

Load heads 60 were adjusted to apply ½ of load PF (kN) to a portion between the short leg members 20c and 20d and to a portion between the short leg members 20d and 20e. A sinking volume in the middle of the top plate 10 was defined as a displacement δ (mm) due to the load PF. The result of the load test is shown in FIG. 7.

In FIG. 7, a horizontal axis represents the displacement δ (mm) and the vertical axis represents the load PF (kN). As the load was applied, a displacement amount increased, and a break occurred when the load exceeded 10 kN. The load observed immediately before breakage can be regarded as maximum proof strength. In this test, the maximum proof strength was 10 kN or more. The value was equivalent to approximately 1 t (1000 kilogram-weight), indicating that the easy-assembly bed had sufficient proof strength.

### INDUSTRIAL APPLICABILITY

The easy-assembly bed according to the present invention can be suitably used as an emergency bed, and is also usable as a regular bed since it is lightweight and excellent in portability. The easy-assembly bed according to the present invention can also be used as a multipurpose table. Furthermore, the easy-assembly bed according to the present invention has a top plate that is usable as a medical lightweight board.

### REFERENCE SIGNS LIST

1 easy-assembly bed
2 easy-assembly bed
4 easy-assembly bed
3 half table
3a first half table
3b second half table
10 top plate
12a regulation shape
12b link shape
12c leg
14 top plate
14a top plate
14b top plate
16 top plate
20, 20a, 20b, 20c, 20d, 20e leg member
22 locking groove
30 leg portion
40 bed member
42 foam plate
44 front board member
46 rear board member
48 bonded material
48t thickness
48a cut end
48f penetrated region
50 molded resin portion
50L formation length
50t thickness
52 additional shape portion
60 load head

1. An easy-assembly bed comprising: a top plate and a leg portion, the leg portion having a plurality of leg members that are linked using notched joints, wherein:
the top plate is constituted of
a bonded material, which includes a plate-shaped foam plate formed with a foam body, and a front board member and a rear board member that have an identical shape to the foam plate and that are bonded to a rear surface and a front surface of the foam plate, respectively, and
a top plate molded resin portion covering cut ends of the bonded material with a molded resin; and
the leg members are each constituted of
a grooved bonded material, which includes a plate-shaped grooved foam plate having locking grooves and formed with a foam body, and a grooved front board member and a grooved rear board member on a front surface and a rear surface of the grooved foam plate, respectively, the grooved front and rear members having an identical shape to the grooved foam plate, and
a leg member molded resin portion covering cut ends of the grooved bonded material with a molded resin.

2. The easy-assembly bed according to claim 1, wherein a total specific gravity of the top plate and the leg portion is 0.6 g/cm³ or less.

3. The easy-assembly bed according to claim 1, wherein the top plate molded resin portion includes an additional shape portion formed continuously on the top plate molded resin portion.

4. The easy-assembly bed according to claim 3, wherein the additional shape portion has a regulation shape configured to regulate both the top plate and the leg portion.

5. The easy-assembly bed according to claim 1, wherein the top plate is constituted of a plurality of the top plates adjacent to one another.

6. The easy-assembly bed according to claim 5, wherein the top plate molded resin portion includes an additional shape portion formed continuously on the top plate molded resin portion.

7. The easy-assembly bed according to claim 5, wherein the additional shape portion has a regulation shape configured to regulate both the top plate and the leg portion.

8. The easy-assembly bed according to claim 7, wherein the additional shape portion has a link shape configured to further link the top plates adjacent to each other.

9. A multipurpose table comprising: a top plate, and a leg portion having a plurality of leg members that are linked using notched joints, wherein:
the top plate is constituted of
a bonded material, which includes a plate-shaped foam plate formed with a foam body, and a front board member and a rear board member that have an identical shape to the foam plate and that are bonded to a rear surface and a front surface of the foam plate, respectively, and
a top plate molded resin portion covering cut ends of the bonded material with a molded resin; and
the leg members are each constituted of
a grooved bonded material, which includes a plate-shaped grooved foam plate having locking grooves and formed with a foam body, and a grooved front board member and a grooved rear board member on a front surface and a rear surface of the grooved foam plate, respectively, the grooved front and rear members having an identical shape to the grooved foam plate, and
a leg member molded resin portion covering cut ends of the grooved bonded material with a molded resin.

10. A medical transportation lightweight board comprising:
a bonded material, which includes a plate-shaped foam body, and a front board member and a rear board member that have an identical shape to the foam body and that are bonded to a rear surface and a front surface of the foam body, respectively; and
a molded resin portion covering cut ends of the bonded material with a molded resin.

11. The medical transportation lightweight board according to claim 10, wherein the molded resin portion includes a leg formed continuously on the molded resin portion as an additional shape portion.
